(19) United States
(12) Patent Application Publication
(10) Pub. No.: US 2025/0168932 A1
(43) Pub. Date: May 22, 2025

(54) HEATER AND HEATING MEMBER

(71) Applicant: NGK INSULATORS, LTD., Nagoya-City (JP)

(72) Inventors: Shuichi ICHIKAWA, Nagoya-Shi (JP); Koji KUZUTANI, Konan-Shi (JP); Yukio MIYAIRI, Nagoya-Shi (JP)

(73) Assignee: NGK INSULATORS, LTD., Nagoya-City (JP)

(21) Appl. No.: 18/922,534

(22) Filed: Oct. 22, 2024

(30) Foreign Application Priority Data
Nov. 20, 2023 (JP) 2023-196927

(51) Int. Cl. H05B 3/28; B32B 3/18; B32B 9/00; B32B 17/06

(52) U.S. Cl. CPC H05B 3/283; B32B 3/18; B32B 9/005; B32B 17/06; B32B 17/061; B32B 2307/54; B32B 2457/00; H05B 2203/016

(57) ABSTRACT

A heater includes: a first ceramic substrate; a glass portion provided on the first ceramic substrate; and an electrically heating portion embedded in the glass portion. The glass portion has closed pores. The electrically heating portion includes a metal wherein a rate of change of a mass at 700° C. relative to a mass at 25° C. in the air atmosphere is 0.1% or lees.

### CROSS REFERENCE TO RELATED APPLICATIONS

The present invention claims the benefit of priority to Japanese Patent Application No 2023-196927 filed on Nov. 20, 2023 with the Japanese Patent Office, the entire contents of which are incorporated herein by reference in its entirety.

### FIELD OF THE INVENTION

The present invention relates to a heater and a heating member.

### BACKGROUND OF THE INVENTION

There is an increasing demand for reduction of harmful components (HC, NOx, CO) in exhaust gases from motor vehicles. In particular, purification of NOx emitted from diesel engines is an important issue. A technology called a urea SCR system is generally known in the art as a measure for removing NOx. In the urea SCR system, thermal decomposition and hydrolysis of urea produce NH₃, which is a NOx reducing agent. Efficient heating of urea is required for efficient thermal decomposition and hydrolysis of urea. However, with improvement of an engine efficiency, a temperature of the exhaust gas has been decreased, and the temperature of the exhaust gas is also lower immediately after the engine is started. When the temperature of the exhaust gas is lower, the decomposition reaction does not easily occur even if the urea is injected into the exhaust gas, so that NH₃ is not sufficiently generated. Further, when the injected urea collides with an inner wall surface of an exhaust pipe, a lower temperature of the inner wall surface does not completely decompose the urea into NH₃, so that the urea will be converted to an intermediate solid deposit, which is accumulated. As a result, it will become an obstacle to the flow of the exhaust gas, or inhibit mixing of the generated NH₃ and the exhaust gas due to a change in the flow of the exhaust gas. Therefore, heaters have been developed that can efficiently heat the exhaust gas and maintain the inner wall surface of the exhaust pipe at a high temperature.

Further, in battery electric vehicles (BEVs) and fuel cell vehicles (FCVs) which do not have any heat source from the internal combustion engine, and plug-in hybrid vehicles (PHVs: Plug-in Hybrid Vehicle, PHEVs (Plug-in Hybrid Electrical Vehicles)) which frequently stop the internal combustion engine, an increase in a heating efficiency is an important issue because a heating load affects the traveling distance. Therefore, heaters are being developed that can efficiently heat only a specific space in a short period of time, instead of heating the entire vehicle interior.

Furthermore, to achieve carbon neutrality, the development of synthetic fuels, which are obtained by synthesizing hydrogen produced by the electrolysis of water and CO₂ emitted from power plants and factories, is being progressed, but heating is required for a production process of the synthetic fuel. If the production process is carried out in a place where it is possible to supply factory waste heat or like, the heat source can be easily ensured, but if it is carried out in a place where there is no heat source, it must be heated using electric power. The electric power is preferably produced from renewable energy that does not emit CO₂ during the production process, so that the heater is also required to have an improved heating efficiency.

A heater in which conductors are embedded in substrates with a low heat capacity or the conductor is arranged between the substrates is one of effective heating means for various applications as described above.

For example, Patent Literature 1 proposes a heater, comprising: a plate-shaped first heater substrate; a heating wire arranged in a parallel circuit on a first surface of the first heater substrate; an electrode connected to the heating wire for energizing the heating wire; and a plate-shaped cover substrate for covering the first surface of the first heater substrate, the heating wire, and the electrode on a second surface side. In this heater, the first heater substrate and/or the cover substrate contain Si₃N₄ or Al₂O₃, and the heating wire contains at least one metal selected from the group consisting of WC, TiN, TaC, ZrN, MoSi₂, Pt, Ru and W.

Patent Literature 2 proposes a heater, comprising: an insulating substrate made of alumina ceramics, silicon nitride ceramics, or the like; and a resistor embedded in the insulating substrate, wherein the resistor contains first conductive particles mainly based on tungsten and second conductive particles mainly based on molybdenum.

Patent Literature 3 proposes a mixer for exhaust gas purification devices, comprising: an outer cylinder made of insulating ceramics such as alumina, silicon nitride, and cordierite; fins made of insulating ceramics, which are provided inside the outer cylinder; and an electrically heating portion embedded in at least a part of the outer cylinder and/or the fins.

Heaters used for the applications as described above are required to be able to heat quickly and efficiently, and to have long-term durability in harsh environments (specifically, environments requiring corrosion resistance, heat resistance, impact resistance, insulation, etc.).

However, for the heaters described in the prior arts described above, it is difficult to ensure long-term durability in harsh environments depending on the types of substrates and conductors. For example, since an alumina substrate has a high coefficient of thermal expansion, it is difficult to ensure long-term durability in environments with large temperature changes because thermal stress increases. Further, although a cordierite substrate has a low coefficient of thermal expansion, when a conductor having a high coefficient of thermal expansion is embedded in the cordierite substrate or a conductor is arranged between the cordierite substrates, cracks are easily generated in the cordierite substrate due to a difference in coefficient of thermal expansion in environments with large temperature changes, so that it is difficult to ensure long-term durability. Furthermore, conductors such as molybdenum and tungsten are easily oxidized when exposed to elevated temperature in the presence of a small amount of air, and as the oxidation progresses, there is a risk that disconnection eventually occurs, so that it is difficult to ensure long-term durability.

The present invention is made to solve the above problems. An object of the present invention is to provide a heater and a heating member, which have long-term durability even in harsh environments.

### PRIOR ART

### Patent Literatures

[Patent Literature 1] Japanese Patent Application Publication No. 2017-182890 A
[Patent Literature 2] Japanese Patent No. 5748918 B
[Patent Literature 3] Japanese Patent Application Publication No. 2020-197208 A

### SUMMARY OF THE INVENTION

As a result of intensive studies, the present inventors have found that the above problems can be solved by embedding a specific electrically heating portion (conductor) in a glass portion having closed pores to provide it in a ceramic substrate, and they have completed the present invention.

[1]

A heater, comprising: a first ceramic substrate; a glass portion provided on the first ceramic substrate; and an electrically heating portion embedded in the glass portion,
wherein the glass portion has closed pores, and
wherein the electrically heating portion comprises a metal wherein a rate of change of a mass at 700° C. relative to a mass at 25° C. in the air atmosphere is 0.1% or less.
   [2]

The heater according to [1], further comprising a second ceramic substrate provided on the glass portion.

[3]

The heater according to [1] or [2], wherein the ceramic substrate is a cordierite substrate.

[4]

The heater according to any one of [1] to [3], wherein the glass portion has a coefficient of thermal expansion of less than 6.0×10⁻⁶/K.

[5]

The heater according to any one of [1] to [4], wherein the glass portion has a Young's modulus of 5 to 50 GPa.

[6]

The heater according to any one of [1] to [5], wherein the glass portion comprises boron and/or silicon and has a glass transition temperature of 600 to 1100° C.

[7]

The heater according to any one of [1] to [6], wherein the electrically heating portion has a rate of change of a volume resistivity at 300° C. relative to a volume resistivity at 25° C. of 10% or less.

[8]

The heater according to any one of [1] to [7], wherein the electrically heating portion comprises an alloy containing one or more selected from Ni, Fe, and Cr.

[9]

The heater according to [8], wherein the alloy is a Ni—Cr alloy or an Fe—Cr alloy.

[10]

The heater according to any one of [1] to [9], further comprising a terminal connected to the electrically heating portion.

[11]

The heater according to [10], wherein the terminal is connected to the electrically heating portion via a brazing material.

[12]

The heater according to any one of [1] to [11], wherein the heater is used for heating an exhaust gas.

[13]

A heating member, comprising:
a cylindrical member;
the heaters according to any one of [1] to [12], each of the heaters being disposed along an inner peripheral surface of at least a part of the cylindrical member; and
an insulating material disposed between the cylindrical member and each of the heaters;
wherein the electrically heating portions of the heaters can be electrically connected to a power source in series or in parallel.
   [14]

The heating member according to used for heating a reducing agent precursor to generate a reducing agent,
wherein the heating member further comprises a nozzle capable of injecting the reducing agent precursor on an inner peripheral surface of the cylindrical member, the nozzle being disposed on at least a part of the cylindrical member,
wherein each of the heaters is disposed on the inner peripheral surface of the cylindrical member onto which the reducing agent precursor is injected through the nozzle, and
wherein the cylindrical member is an exhaust pipe for a diesel engine.
   [15]

The heating member according to [14],
wherein each of the electrically heating portions of the heaters has one end electrically connected to the power source and the other end electrically connected to the cylindrical member, and
wherein a voltage applied from the power source is 80 V or less.

### BRIEF DESCRIPTION OF THE DRAWINGS

FIG. 1A is a top view of a heater according to an embodiment of the present invention;

FIG. 1B is a cross-sectional view taken along the line a-a′ in FIG. 1A;

FIG. 1C is an enlarged cross-sectional view of the region R in FIG. 1B;

FIG. 2 is a graph showing a relationship between temperatures of Mo, W, Ni—Cr alloy, Fe—Cr alloy, and Fe—Ni alloy and a rate of change R1 of a mass at 700° C. relative to a mass at 25° C.;

FIG. 3A is a result of evaluation of durability for a heater 100 using a Ni—Cr alloy as an electrically heating portion;

FIG. 3B is a result of evaluation of durability for a heater using W as an electrically heating portion;

FIG. 3C is a result of evaluation of durability for a heater using Mo as an electrically heating portion;

FIG. 4 is a schematic view for explaining an arrangement pattern of a linear electrically heating portion;

FIG. 5A is a top view of a heater according to another embodiment of the present invention;

FIG. 5B is a cross-sectional view taken along the line b-b′ in FIG. 5A;

FIG. 6 is a cross-sectional view of a heating member according to an embodiment of the present invention;

FIG. 7 is a top view showing a state where electrically heating portions of multiple heaters according to an embodiment of the present invention are electrically connected in series to a power source;

FIG. 8 is a top view showing a state where electrically heating portions of multiple heaters according to an embodiment of the present invention are electrically connected in parallel to a power source; and

FIG. 9 is a cross-sectional view of a heating element according to an embodiment of the present invention used for heating a reducing agent precursor to generate a reducing agent.

### DETAILED DESCRIPTION OF THE INVENTION

A heater according to the present invention includes: a first ceramic substrate; a glass portion provided on the first ceramic substrate; and an electrically heating portion embedded in the glass portion, wherein the glass portion has closed pores, and wherein the electrically heating portion includes a metal wherein a mass change rate at 700° C. relative to a mass at 25° C. in the air atmosphere is 0.1% or less. In a heater having such a structure, the glass portion functions as an intermediate region for reducing a difference in coefficient of thermal expansion between the first ceramic substrate and the electrically heating portion. Also, the Young's modulus can be reduced by the closed pores in the glass portion, so that thermal stress in harsh environments is reduced. Furthermore, by using a metal in which a change of rate of a mass at 700° C. relative to the mass at 25° C. is 0.1% by mass or less, the metal is difficult to be oxidized even at elevated temperature. Therefore, the heater has long-term durability even in harsh environments.

A heating member according to the present invention includes: a cylindrical member; the heaters, each of the heaters being disposed along an inner peripheral surface of at least a part of the cylindrical member; and an insulating material disposed between the cylindrical member and each of the heaters; wherein the electrically heating portions of the heaters can be electrically connected to a power source in series or in parallel. The heating member includes the above heaters, and therefore has long-term durability even in harsh environments.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### (1) Heater

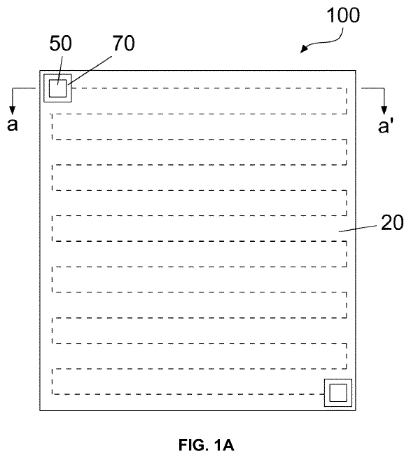

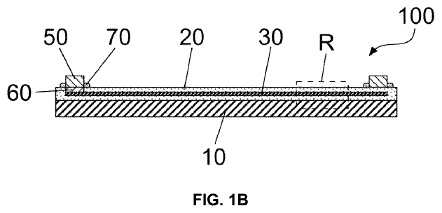

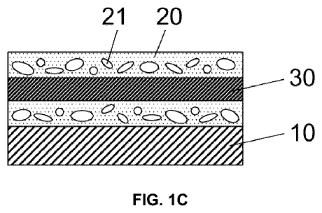

FIG. 1A is a top view of a heater according to an embodiment of the present invention, and FIG. 1B is a cross-sectional view of this heater taken along the line a-a′. FIG. 1C is an enlarged cross-sectional view of the region R in FIG. 1B.

As shown in FIGS. 1A to 1C, a heater 100 includes: a first ceramic substrate 10; a glass portion 20 provided on the first ceramic substrate 10; and an electrically heating portion 30 embedded in the glass portion 20. It should be noted that in FIG. 1A, the dotted line indicates the position of the electrically heating portion 30 embedded in the glass portion 20. The glass portion 20 has a coefficient of thermal expansion between the first ceramic substrate 10 and the electrically heating portion 30, and therefore can reduce a difference in coefficient of thermal expansion between the first ceramic substrate 10 and the electrically heating portion 30, thereby reducing thermal stress in harsh environments. Also, since the first ceramic substrate 10 and the electrically heating portion 30 are not in direct contact with each other, the generation of cracks in the first ceramic substrate 10 can be suppressed.

Hereinafter, each member will be described.

### <First Ceramic Substrate 10>

The first ceramic substrate 10 may be a substrate containing an insulating ceramic such as alumina, silicon nitride and cordierite as a main component, although not particularly limited thereto. Among these, from the viewpoint of stably ensuring long-term durability in harsh environments, it is preferable that the first ceramic substrate 10 is a cordierite substrate.

As used herein, the cordierite substrate refers to a substrate containing cordierite (2MgO·2Al₂O₃·5SiO₂) as a main component.

As used herein, the term “main component” means a component in which a percentage of the component relative to the total component is more than 50% by mass, and preferably 90% by mass or more.

The cordierite substrate is preferably comprised of 90% by mass or more of a cordierite phase, 5% by mass or less of a crystalline phase containing mullite and/or spinel, the balance being a glass phase. Such a composition can allow properties such as a coefficient of thermal expansion and Young's modulus to be controlled within desired ranges.

As used herein, the % by mass of each phase in the cordierite substrate is determined as follows. First, a plurality of samples are prepared by mixing cordierite, mullite, spinel and glass at variable mass ratios, and a calibration curve of X-ray diffraction peak values is created in advance. The peak values are determined by X-ray diffraction of the cordierite substrate, and the mass ratio (% by mass) of each phase in the cordierite substrate is determined based on the calibration curve.

The first ceramic substrate 10 preferably has an open porosity of 10% or less, and more preferably 5% or less, although not particularly limited thereto. When the heater 100 is used in an environment where a liquid such as a reducing agent precursor (e.g., urea water) adheres, the control of the open porosity to that range can make it difficult for the liquid to penetrate to the interior of the first ceramic substrate 10.

Here, the open porosity of the first ceramic substrate 10 can be measured using an existing test method (Archimedes method, JIS R 1634:1998). The open porosity of the first ceramic substrate 10 can be controlled by reducing a particle size of a raw material powder or by adding a sintering aid or the like.

The first ceramic substrate 10 preferably has a coefficient of thermal expansion (rate of thermal expansion) of 1.5×10⁻⁶ to 2.0×10⁻⁶/K, although not particularly limited thereto. With the coefficient of thermal expansion within such a range, thermal stress can be stably reduced in the harsh environment with large thermal fluctuations, so that the long-term durability of the heater 100 is improved.

Here, the coefficient of thermal expansion of the first ceramic substrate 10 can be measured according to JIS R 1618:2002.

The first ceramic substrate 10 preferably has a Young's modulus of 160 GPa or less, although not particularly limited thereto. The Young's modulus within this range can stably reduce the thermal stress in the harsh environments with large thermal fluctuations, so that the long-term durability of the heater 100 is improved. Moreover, the Young's modulus of the first ceramic substrate 10 is preferably 100 GPa or more from the viewpoint of suppressing deformation and breakage of the heater 100 due to vibration.

Here, the Young's modulus of the first ceramic substrate 10 can be calculated as follows. The bending strength of the first ceramic substrate 10 is measured according to the four-point bending strength test method defined in JIS R 1601:2008, and a “stress-strain curve” is created from the measurement results. A slope of the “stress-strain curve” thus obtained is calculated, and the slope of the “stress-strain curve” is defined as Young's modulus.

### <Glass Portion 20>

The glass portion 20 has closed pores 21. The presence of the closed pores 21 in the glass portion 20 reduces the Young's modulus of the glass portion 20, thereby reducing thermal stress in harsh environments with large thermal fluctuations.

As used herein, the “closed pores 21” refer to pores that are independently present in the glass portion 20 and are not connected to the outside. The glass portion 20 having the closed pores 21 can be formed by a method known in the art (such as control of components and production conditions). Also, open pores on the surface of the glass portion 20 having the open pores may be filled with a repair material or the like to make the closed pores. The repair material may be glass or another material.

The glass portion 20 preferably has a coefficient of thermal expansion (rate of thermal expansion) of less than 6.0×10⁻⁶/K, and more preferably 2.0×10⁻⁶ to 5.0×10⁻⁶/K, and even more preferably 2.0×10⁻⁶ to 4.0×10⁻⁶/K, although not particularly limited thereto. The coefficient of thermal expansion of the glass portion 20 within the above range can reduce the difference between the coefficients of thermal expansion of the glass portion 20 and the first ceramic substrate 10. As a result, the thermal stress can be reduced in the harsh environments with large thermal fluctuations, so that the long-term durability of the heater 100 is improved.

Here, the coefficient of thermal expansion of the glass portion 20 can be measured in the same manner as the coefficient of thermal expansion of the first ceramic substrate 10.

The glass portion 20 preferably has a Young's modulus of 5 to 50 GPa, and more preferably 5 to 40 GPa, although not particularly limited thereto. The Young's modulus in this range can stably reduce thermal stress in harsh environments with large thermal fluctuations, so that the long-term durability of the heater 100 can be improved.

The Young's modulus of the glass portion 20 can be measured in the same manner as the Young's modulus of the first ceramic substrate 10.

The glass portion 20 can be formed using various known glasses.

The glass portion 20 generally contains boron and/or silicon. Examples of glasses used for the glass portion 20 include quartz glass, borosilicate glass, soda-lime glass, aluminoborosilicate glass, aluminosilicate glass, and crystallized glass. Among these, borosilicate glass is preferred because of its high heat resistance and low coefficient of thermal expansion (low rate of thermal expansion).

Furthermore, the glass portion 20 preferably has a glass transition temperature (Tg) of 600 to 1100° C. The glass transition temperature in this range can increase the heat resistance, thereby improving the long-term durability of the heater 100.

Here, the glass transition temperature of the glass portion 20 can be measured in accordance with JIS R3103-3:2001.

### <Electrically Heating Portion 30>

The electrically heating portion 30 is a conductor that generates heat by electrical conduction. The electrically heating portion 30 is made of a metal in which a rate of change R1 of a mass at 700° C. relative to a mass at 25° C. in the air atmosphere is 0.1% or less. By making the electrically heating portion 30 from such a metal, it will be difficult to be oxidized even under high temperature conditions, thereby improving the long-term durability of the heater 100.

The rate of change R1 of the mass at 700° C. relative to the mass at 25° C. can be calculated by using a thermogravimetric differential thermal analysis (TG-DTA) device to measure a mass change associated with a temperature change of the metal, in accordance with the following equation from the measured masses of the metal at 25° C. and 700° C.:

$$Rate of change R 1 = ( mass at 25 ° C . - mass at 700 ° C . ) / mass at 25 ° C . \times 100.$$

The metal having the above rate of change R1 of the mass is not particularly limited, but an alloy containing one or more selected from Ni, Fe, and Cr can be used. Examples of the alloy include Ni—Cr alloys and Fe—Cr alloys. These can be used alone or in combination. The use of such an alloy allows oxidation under high temperature conditions to be stably suppressed.

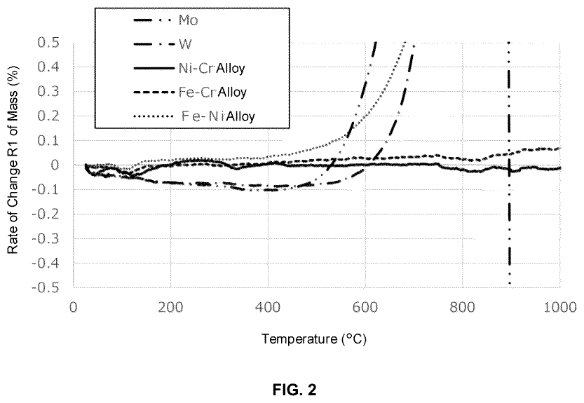

For reference, FIG. 2 shows a graph showing the relationship between the temperature and the rate of change R1 of the mass at 700° C. relative to the mass at 25° C. for Mo (molybdenum), W (tungsten), Ni—Cr alloy, Fe—Cr alloy, and Fe—Ni alloy (Invar), as measured and calculated using a TG-DTA device.

As shown in FIG. 2, only the Ni—Cr alloy and Fe—Cr alloy of the illustrated metals have the rate of change R1 of the mass at 700° C. relative to the mass at 25° C. of 0.1% or less, indicating that they are resistant to oxidation even under high temperature conditions.

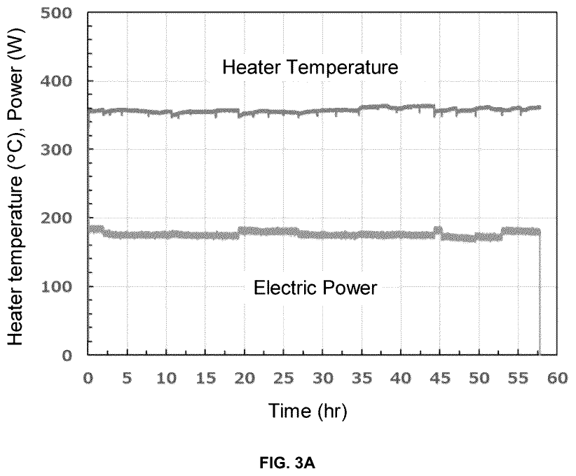

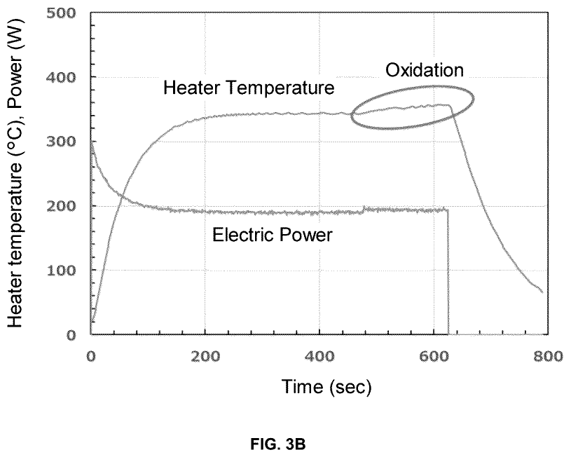

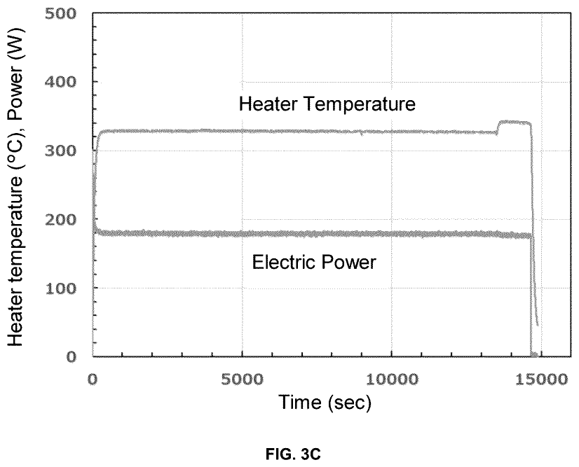

Further, the heaters 100 were actually produced using Ni—Cr alloy, W, and Mo as the electric heating portions 30, and the durability of the heaters 100 was evaluated. In this evaluation, the cordierite substrate was used as the first ceramic substrate 10, and the borosilicate glass having the closed pores 21 was used as the glass portion 20. The durability was evaluated by applying a voltage to each heater 100 and measuring the temperature of the heater over time. The evaluation results of the durability of the heater 100 using the Ni—Cr alloy as the electrically heating portion 30 are shown in FIG. 3A, the evaluation results of the durability of the heater 100 using W as the electrically heating portion 30 are shown in FIG. 3B, and the evaluation results of the durability of the heater 100 using Mo as the electrically heating portion 30 are shown in FIG. 3C.

As shown in FIG. 3A, for the heater 100 using the Ni—Cr alloy as the electrically heating portion 30, substantially no change of the temperature of the heater 10 was observed even after 55 hours of voltage application.

In contrast, as shown in FIG. 3B, for the heater 100 using W as the electrically heating portion 30, the temperature of the heater 100 was reduced after about 620 seconds. The investigation of the cause of this confirmed that the electrically heating portion 30 had been disconnected.

Also, as shown in FIG. 3C, for the heater 100 using Mo as the electrically heating portion 30, the temperature of the heater 100 was reduced after about 14,500 seconds (about 4 hours). The investigation of the cause of this confirmed that the electrically heating portion 30 had been disconnected.

It is preferable that a rate of change R2 of a volume resistivity at 300° C. relative to a volume resistivity at 25° C. of the electrically heating portion 30 is 10% or less. If the rate of change R2 of the volume resistivity is in this range, it can be said that there is a little change of the volume resistivity even if the temperature is changed, and heating performance can be stably maintained even under high temperature conditions.

The volume resistivity of the electrically heating portion 30 at each temperature can be measured by the four-terminal method.

The coefficient of thermal expansion of the electrically heating portion 30 is not particularly limited, but it may preferably be 2.0×10⁻⁶ to 15.0×10⁻⁶/K, and more preferably 2.0×10⁻⁶ to 14.0×10⁻⁶/K. Since the thermal expansion of the electrically heating portion 30 can be absorbed by the closed pores 21 of the glass part 20, the coefficient of thermal expansion of the electrically heating portion 30 may be relatively high.

The shape of the electrically heating portion 30 is not particularly limited, and it may be various shapes such as a linear shape, a plate shape, and a sheet shape. It should be noted that FIGS. 1A to 1C show an example where a linear electrically heating portion 30 is formed.

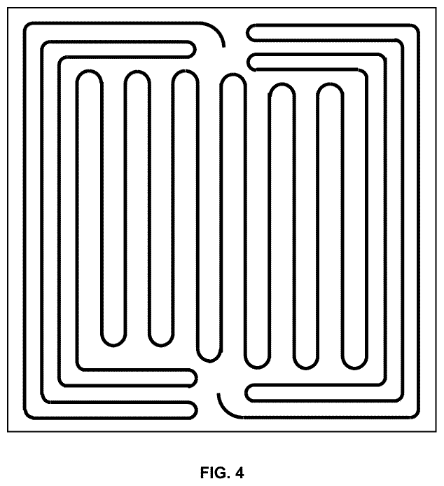

When the electrically heating portion 30 is linear, its arrangement pattern is not particularly limited, and it may be, for example, the arrangement pattern as shown by the dotted line in FIG. 1A. Since the outer periphery of the heater 100 is easily cooled, it is preferable to increase the density of the linear electrically heating portion 30 at the outer periphery of the heater 100 (i.e., narrow the interval between the linear electric heating portions 30) as shown in FIG. 4, in terms of uniform heating of the heater 100. It should be noted that FIG. 4 is a schematic view for explaining the arrangement pattern of the linear electrically heating portion 30 (a cross-sectional view of the electrically heating portion 30 parallel to the upper surface of the heater 100).

A second ceramic substrate can be further provided on the glass portion 20 in which the electrically heating portion 30 is embedded.

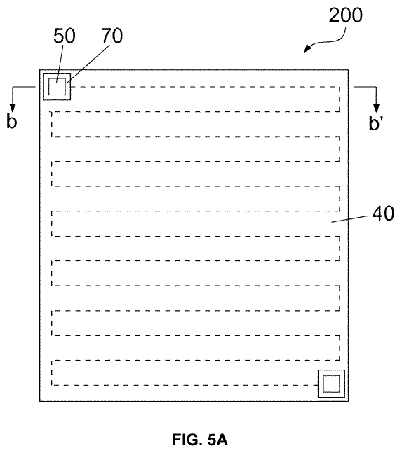

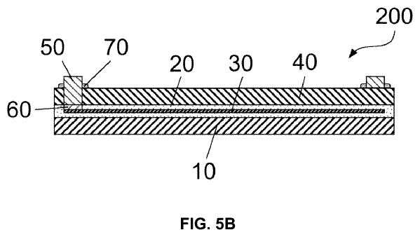

Here, FIG. 5A shows a top view of a heater further including a second ceramic substrate, and FIG. 5B shows a cross-sectional view of the heater taken along the line b-b′.

As shown in FIGS. 5A and 5B, a heater 200 includes: a first ceramic substrate 10; a glass portion 20 provided on the first ceramic substrate 10; an electrically heating portion 30 embedded in the glass portion 20; and a second ceramic substrate 40 provided on the glass portion 20. It should be noted that in FIG. 5A, the dotted line indicates the position of the electrically heating portion 30 embedded in the glass portion 20. In the heater 200 having such a structure, the glass portion 20 functions as an intermediate region that reduces the difference in coefficient of thermal expansion between the first and second ceramic substrates 10, 40 and the electrically heating portion 30. Also, the Young's modulus can be reduced by the closed pores 21 of the glass portion 20, so that thermal stress in harsh environments is reduced. Furthermore, since the first and second ceramic substrates 10, 40 are prevented from coming into direct contact with the electrically heating portion 30, cracks in the first ceramic substrate 10 and the second ceramic substrate 40 can be suppressed. Therefore, the long-term durability of the heater 200 is improved.

The second ceramic substrate 40 can be the same as the first ceramic substrate 10, and so details will be omitted.

The type of the second ceramic substrate 40 may be the same as or different from the first ceramic substrate 10, but it is preferable that they are the same as each other. By making the first ceramic substrate 10 and the second ceramic substrate 40 the same type, the thermal stress in harsh environments with large thermal fluctuations can be stably reduced, thereby improving the long-term durability of the heater 200.

The heater 100, 200 may further include terminals 50 each connected to the electrically heating portion 30 via a brazing material 60, as shown in FIGS. 1A to 1B and 5A to 5B. Such a structure makes it easy to electrically connect the electrically heating portion 30 to an external power source (not shown).

The terminal 50 is comprised of a conductor capable of energization. The conductor used for the terminal 50 is not particularly limited, and metals or alloys known in the art may be used. Among them, the conductor used for the terminal 50 preferably contains Fe, Ni and Co. As such a material, Kovar can be used, for example.

It should be noted that the conductor used for the terminal 50 may be comprised of the same conductor as the electrically heating portion 30, or may be comprised of a conductor different from that of the electrically heating portion 30.

The conductor making up the terminal 50 preferably has a coefficient of thermal expansion (rate of thermal expansion) of more than 1.6×10⁻⁶/K and less than 6.0×10⁻⁶/K, and more preferably more than 3.0×10⁻⁶/K and less than 6.0×10⁻⁶/K or less, although not particularly limited thereto. The coefficient of thermal expansion of the conductor making up the terminal 50 within the above range can reduce the difference between the coefficients of thermal expansion of the second ceramic substrate 40 and the conductor making up the terminal 50 in the heater 200 as shown in FIGS. 5A and 5B. As a result, the thermal stress can be reduced in the environment with large thermal fluctuations, so that the reliability of the heater 200 is improved. For example, Kovar has a coefficient of thermal expansion of about 5.0×10⁻⁶/K.

In heater 200 as shown in FIGS. 5A and 5B, each terminal 50 is preferably inserted into a through-hole provided in second ceramic substrate 40. Such a structure makes it easy to electrically connect the electrically heating portion 30 to the external power source (not shown).

The brazing material 60 is a material for joining the electrically heating portion 30 to the terminal 50. The brazing material 60 is not particularly limited, and an appropriate material may be selected depending on types of the electrically heating portion 30 and the terminals 50. For example, the brazing material 60 preferably contains Ag, Ti and Cu. If the brazing material 60 contains such components, the electrically heating portion 30 and the terminals 50 can be appropriately joined without affecting them.

The heater 100, 200 may further include a sealing portion 70 provided at a boundary surface between the terminal 50 and the glass portion 20 or the second ceramic substrate 40, as shown in FIGS. 1A to 1B and 5A to 5B. More particularly, the heater 100 can be provided with the sealing portion 70 at the boundary surface between the terminal 50 and the glass portion 20. Also, the heater 200 can be provided with a sealing portion 70 at the boundary surface between the terminal 50 and the second ceramic substrate 40. Such a structure can suppress intrusion of liquid, air or the like from the boundary, so that the reliability of the heater 100, 200 can be improved.

A material for forming the sealing portion 70 is not particularly limited, and known sealing materials in the art may be used. Among them, the material forming the sealing portion 70 is preferably glass.

Also, the sealing portion 70 (glass) preferably contains SiO₂ and B₂O₃. Since the sealing portion 70 containing such components has a lower coefficient of thermal expansion, the cracks in the sealing portion 70 and members around it (the glass portion 20 and the second ceramic substrate 40) can be suppressed.

The glass making up the sealing portion 70 preferably has a coefficient of thermal expansion (a rate of thermal expansion) of more than 1.6×10⁻⁶/K and less than 6.0×10⁻⁶/K, and more preferably more than 2.0×10⁻⁶/K and less than 4.0×10⁻⁶/K, although not particularly limited thereto. The coefficient of thermal expansion of the glass making up the sealing portion 70 within the range as described above reduces the difference between the coefficients of the thermal expansion of the glass portion 20, and the conductor making up the terminal 50 and the glass making up the sealing portion 70 for the heater 100, and reduces the difference between the coefficients of thermal expansion of the second ceramic substrate 40, and the conductor making up the terminal 50 and the glass making up the sealing portion 70 for the heater 200. As a result, the thermal stress in the harsh environments with large thermal fluctuations can be reduced, so that the reliability of the heater 100, 200 can be improved.

The heaters 100, 200 having the structures as described above can be used for various applications, because they have long-term durability even in harsh environments, and can also suppress the generation of cracks in the ceramic substrates (the first ceramic substrate 10 and the second ceramic substrate 40).

For example, the heaters 100, 200 are useful for heating an exhaust gas in an exhaust gas mixer that mixes urea and the exhaust gas in a diesel engine urea SCR system. In the urea SCR system, the heaters 100, 200 are also useful for maintaining a high temperature of the inner wall surface of the cylindrical member (exhaust pipe) that forms the exhaust gas mixer, and preventing the urea from becoming an intermediate solid deposit to be accumulated when the urea collides with the inner wall surface. In the urea SCR system, ammonia (NH₃) that will be used as a NOx reducing agent can be produced by injecting urea water into the exhaust gas heated by the heaters 100, 200.

Each of the heaters 100, 200 is also useful as heating equipment for electric vehicles, fuel cell vehicles, and plug-in hybrid vehicles, and as a heating means for the production process of the synthetic fuel.

The heaters 100, 200 can be produced according to methods known in the art.

For example, the heater 100 can be produced as follows:

First, a forming material containing ceramic raw material powder is formed and then sintered to produce the first ceramic substrate 10. Although the forming method is not particularly limited, extrusion molding, mold cast molding, or the like may be used. Alternatively, the first ceramic substrate 10 may be produced by machining a sintered body having a predetermined shape.

The electrically heating portion 30 is then sandwiched between two glass sheets that will form the glass portion 20, and arranged on the first ceramic substrate 10 to form a stacked structure. At this time, the glass sheet on the surface side is provided with an opening for connecting the electrically heating portion 30 to each terminal 50 with the brazing material 60. Also, when a glass sheet having open pores is used as the glass sheet, a pore-closing treatment is performed to close the open pores on the surface with a repair material such as glass. If a glass sheet having closed pores is used, the pore-closing treatment is not required.

The stacked structure is then integrated by a heating and pressing process. At this time, the glass sheets are integrated to form the glass portion 20, and the electrically heating portion 30 is embedded in the glass portion 20. Although the heating and pressing conditions are not particularly limited, they may be appropriately set according to the type of the glass sheets to be used.

Each terminal 50 is then placed on the electrically heating portion 30 exposed in the opening of the glass sheet on the surface side via the brazing material 60, and then heated and joined. Although the heating conditions are not particularly limited, they may be appropriately set according to the type of the brazing material 60 to be used.

Finally, the sealing material is applied to the boundary between each terminal 50 and the glass portion 20 on the surface of the glass portion 20, and then heated to form the sealing portion 70, thereby completing the heater 100. Although the heating conditions are not particularly limited, they may be appropriately set according to the type of the sealing material to be used.

The heater 200 can be produced as follows:

First, forming materials each containing cordierite raw material powder are formed and then sintered to produce the first ceramic substrate 10 and the second ceramic substrate 40.

The electrically heating portion 30 is then sandwiched between two glass sheets that will form the glass portion 20, and this is placed between the first ceramic substrate 10 and the second ceramic substrate 40 to form a stacked structure. At this time, the second ceramic substrate 40 and the glass sheet on the second ceramic substrate 40 side are provided with an opening for connecting the electrically heating portion 30 to each terminal 50 with the brazing material 60. Also, when a glass sheet having open pores is used as the glass sheet, a pore-closing treatment is performed to close the open pores on the surface with a repair material such as glass. If a glass sheet having closed pores is used, the pore-closing treatment is not required.

The stacked structure is then integrated by heating the stacked structure while pressing it in order to improve the adhesiveness among the first ceramic substrate 10, the second ceramic substrate 40, and the glass sheets sandwiching the electrically heating portion 30.

Each terminal 50 is placed on the electrically heating portion 30 exposed in the opening of the second ceramic substrate 40 and the glass sheet on the second ceramic substrate 40 side via the brazing material 60, and then heated and joined.

Finally, the sealing material is applied to the boundary between each terminal 50 and the second ceramic substrate 40 on the surface of the second ceramic substrate 40, and then heated to form the sealing portion 70, thereby completing the heater 200.

### (2) Heating Member

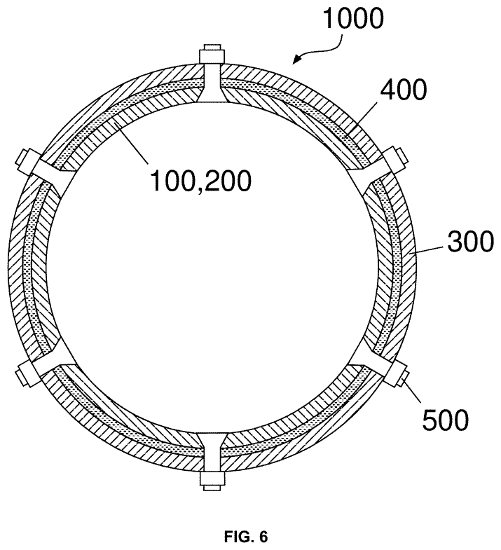

FIG. 6 is a cross-sectional view of a heating member according to an embodiment of the present invention. It should be noted that FIG. 6 is a cross-sectional view of a cylindrical member 300 forming a heating member 1000 in a direction perpendicular to an axial direction.

As shown in FIG. 6, the heating member 1000 includes: a cylindrical member 300; a plurality of the heaters 100, 200 arranged along at least a part of an inner peripheral surface of the cylindrical member 300; and an insulating material 400 disposed between the cylindrical member 300 and the heaters 100, 200. Such a structure can allow the interior of the cylindrical member 300 to be heated.

The cylindrical member 300 is not particularly limited, and it may have a uniform diameter in the axial direction, or may have a decreased and/or increased diameter in the axial direction.

Although the material of the cylindrical member 300 is not particularly limited, it is preferably a metal from the viewpoint of manufacturability. Examples of the metal that can be used herein include stainless steel, titanium alloys, copper alloys, aluminum alloys, and brass. Among them, the stainless steel is preferable because of its high durability and reliability and low cost.

The cylindrical member 300 preferably has a thickness of 0.1 mm or more, and more preferably 0.3 mm or more, and even more preferably 0.5 mm or more, although not particularly limited thereto. The thickness of the cylindrical member 300 of 0.1 mm or more can ensure durability and reliability. Also, the thickness of the cylindrical member 300 is preferably 10 mm or less, and more preferably 5 mm or less, and even more preferably 3 mm or less. The thickness of the cylindrical member 300 of 10 mm or less can achieve weight reduction.

The insulating material 400 is not particularly limited, and a fiber mat made of silicon nitride, alumina, or the like may be used.

A thickness of the insulating material 400 is not particularly limited as long as it can ensure insulation.

The plurality of the heaters 100, 200 are arranged along at least a part of the inner peripheral surface of cylindrical member 300. Although a method for fixing the heaters 100, 200, for example, they may be fixed to the inner peripheral surface of the cylindrical member 300 using fixing jigs such as bolts 500.

The plurality of heaters 100, 200 are configured such that the electrically heating portions 30 can be electrically connected to a power source in series or in parallel. Such a configuration can cause the plurality of the heaters 100, 200 to generate heat by applying a voltage from the power source, and allow the interior of the cylindrical member 300 to be heated.

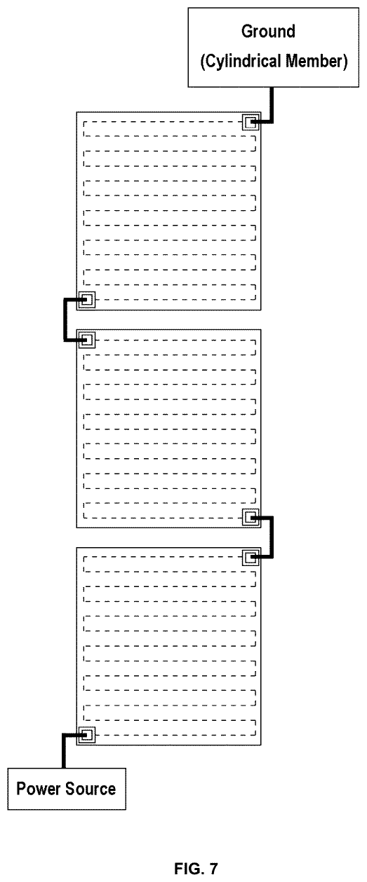

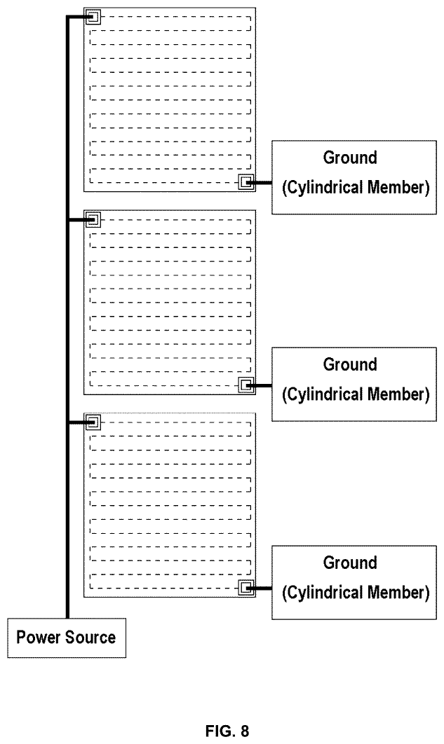

Here, FIG. 7 shows a top view showing a state where the electrically heating portions 30 of the plurality of the heaters 100, 200 are electrically connected to the power source in series. Also, FIG. 8 shows a top view of a state where the electrically heating portions 30 of the plurality of the heaters 100, 200 are electrically connected to the power source in parallel. It should be noted that FIGS. 7 and 8 show the three heaters 100 as a plane view in terms of easy understanding. The dotted lines indicate the positions of the embedded electrically heating portions 30.

In FIG. 7, the electrically heating portions 30 of the plurality of the heaters 100, 200 are electrically connected in series, one end of the electrically heating portions 30 connected in series is electrically connected to the power source, and the other end is electrically connected to a ground (for example, the cylindrical member 300). In FIG. 8, the electrically heating portions 30 of the plurality of the heaters 100, 200 are electrically connected in parallel, one end of each electrically heating portion 30 is electrically connected to the power source, and the other end is electrically connected to a ground (for example, the cylindrical member 300).

Although the voltage applied from the power source is not particularly limited, it is preferably 80 V or less. The voltage in this range do not require special insulation. Further, the applied voltage is preferably 12 V or more, in view of the heating efficiency of the heater 100, 200.

The heating member according to the embodiment of the present invention is suitable for use in the diesel engine urea SCR system. That is, the heating member according to the embodiment of the present invention can be used to maintain a higher temperature of the inner wall surface of the cylindrical member 300 that forms the exhaust gas mixer for mixing a reducing agent precursor (e.g., urea water) with the exhaust gas, and heat the reducing agent precursor to generate a reducing agent (e.g., ammonia) while preventing the urea from becoming an intermediate solid deposit to be accumulated when the urea collides with the inner wall surface.

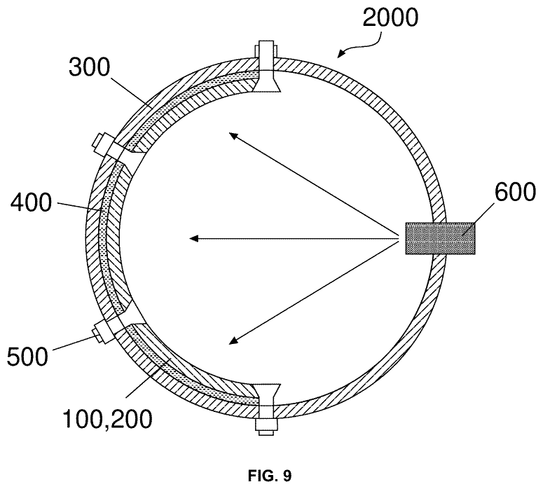

FIG. 9 shows a cross-sectional view of a heating member used for heating the reducing agent precursor to generate the reducing agent. It should be noted that FIG. 9 is a cross-sectional view of a cylindrical member 300 forming a heating member 2000 in a direction perpendicular to the axial direction.

As shown in FIG. 9, the heating member 2000 is arranged on at least part of the cylindrical member 300 and further includes a nozzle 600 capable of injecting the reducing agent precursor onto the inner peripheral surface of the cylindrical member 300. Also, the plurality of the heaters 100, 200 are arranged on the inner peripheral surface of the cylindrical member 300 onto which the reducing agent precursor is injected from the nozzle 600. Furthermore, the cylindrical member 300 is an exhaust pipe of a diesel engine. Such a structure can allow the exhaust gas flowing through the cylindrical member 300 (exhaust pipe) to be heated by the plurality of the heaters 100, 200, so that the reducing agent precursor can be injected into the heated exhaust gas to generate the reducing agent. Further, even if the reducing agent precursor injected from the nozzle 600 collides with the plurality of the heaters 100, 200, the reducing agent precursor evaporates immediately, so that the accumulation of the intermediate produced by decomposition of the reducing agent precursor can also be suppressed.

The heating member 2000 is preferably configured such that electrically heating portions 30 of the plurality of the heaters 100, 200 are electrically connected in parallel. That is, it is preferable that one end of the electric heating portions 30 of the plurality of the heaters 100, 200 are electrically connected to the power source and the other end is electrically connected to the ground (for example, the cylindrical member 300). Also, a voltage applied from the power source is preferably 60 V or less. Such a configuration can allow the reducing agent precursor to be rapidly and efficiently heated to generate the reducing agent, and allow the deposition of the intermediate onto the inner wall surface of the cylindrical member 300 to be suppressed.

### DESCRIPTION OF REFERENCE NUMERALS

10 first ceramic substrate
20 glass portion
21 closed pore
30 electrically heating portion
40 second ceramic substrate
50 terminal
60 brazing material
70 sealing portion
100, 200 heater
300 cylindrical member
400 insulating material
500 bolt
600 nozzle
1000, 2000 heating member

1. A heater, comprising: a first ceramic substrate; a glass portion provided on the first ceramic substrate; and an electrically heating portion embedded in the glass portion,
wherein the glass portion has closed pores, and
wherein the electrically heating portion comprises a metal wherein a rate of change of a mass at 700° C. relative to a mass at 25° C. in the air atmosphere is 0.1% or less.

2. The heater according to claim 1, further comprising a second ceramic substrate provided on the glass portion.

3. The heater according to claim 1, wherein the ceramic substrate is a cordierite substrate.

4. The heater according to claim 1, wherein the glass portion has a coefficient of thermal expansion of less than 6.0×10⁻⁶/K.

5. The heater according to claim 1, wherein the glass portion has a Young's modulus of 5 to 50 GPa.

6. The heater according to claim 1, wherein the glass portion comprises boron and/or silicon and has a glass transition temperature of 600 to 1100° C.

7. The heater according to claim 1, wherein the electrically heating portion has a rate of change of a volume resistivity at 300° C. relative to a volume resistivity at 25° C. of 10% or less.

8. The heater according to claim 1, wherein the electrically heating portion comprises an alloy containing one or more selected from Ni, Fe, and Cr.

9. The heater according to claim 8, wherein the alloy is a Ni—Cr alloy or an Fe—Cr alloy.

10. The heater according to claim 1, further comprising a terminal connected to the electrically heating portion.

11. The heater according to claim 10, wherein the terminal is connected to the electrically heating portion via a brazing material.

12. The heater according to claim 1, wherein the heater is used for heating an exhaust gas.

13. A heating member, comprising:
a cylindrical member;
the heaters according to claim 1, each of the heaters being disposed along an inner peripheral surface of at least a part of the cylindrical member; and
an insulating material disposed between the cylindrical member and each of the heaters;
wherein the electrically heating portions of the heaters can be electrically connected to a power source in series or in parallel.

14. The heating member according to claim 13 used for heating a reducing agent precursor to generate a reducing agent,
wherein the heating member further comprises a nozzle capable of injecting the reducing agent precursor on an inner peripheral surface of the cylindrical member, the nozzle being disposed on at least a part of the cylindrical member,
wherein each of the heaters is disposed on the inner peripheral surface of the cylindrical member onto which the reducing agent precursor is injected through the nozzle, and
wherein the cylindrical member is an exhaust pipe for a diesel engine.

15. The heating member according to claim 14,
wherein each of the electrically heating portions of the heaters has one end electrically connected to the power source and the other end electrically connected to the cylindrical member, and
wherein a voltage applied from the power source is 80 V or less.
